(19) United States
(12) Patent Application Publication
(10) Pub. No.: US 2019/0359432 A1
(43) Pub. Date: Nov. 28, 2019

(54) STOP MODULE

(71) Applicant: Woerner Automatisierungstechnik GmbH, Denkendorf (DE)

(72) Inventor: Stefan STAUCH, Sindelfingen (DE)

(21) Appl. No.: 16/536,759

(22) Filed: Aug. 9, 2019

Related U.S. Application Data
(63) Continuation of application No. PCT/EP2018/054894, filed on Feb. 28, 2018.

(30) Foreign Application Priority Data
Feb. 28, 2017 (DE) 10 2017 104 151.6

(51) Int. Cl. B65G 47/88

(52) U.S. Cl. CPC B65G 47/8823; B65G 2205/06

(57) ABSTRACT

A stop module for stopping an object, which is moved on a transport section with a defined transport direction, comprises a stop element, which can be moved into a transport plane to stop an object, and can be moved out of the transport plane to release the object. The stop module further comprises a fluidic damping device, which is configured to move the stop element in a damped manner from an initial position of the damping device into an end position of the damping device in a working movement during the stopping of the object, wherein the damping device comprises a first piston-cylinder arrangement having a damping piston movable within a damping cylinder. The stop module further comprises a fluidically operated actuator, which is configured to move the stop element optionally into the transport plane in an extension movement or out of the transport plane in a retraction movement, wherein the actuator comprises a second piston-cylinder arrangement having an actuating piston movable within an actuating cylinder. Still further, the stop module comprises a resetting device, which has a pressure line opening into the damping cylinder in order, with the aid of a pressurized fluid passed through said pressure line, to move the damping device back from the end position into the initial position. A duct-like passage opening, which forms a first subsection of the pressure line, is provided in the interior of the actuating piston.

### CROSS REFERENCES TO RELATED APPLICATIONS

This application is a continuation of international patent application PCT/EP2018/054894, filed on Feb. 28, 2018, designating the U.S., which international patent application has been published in German language and claims priority from German patent application DE 10 2017 104 151.6, filed on Feb. 28, 2017. The entire contents of these priority applications are incorporated herein by reference.

### BACKGROUND OF THE INVENTION

The present disclosure relates to a stop module for stopping an object, which is moved on a transport section with a defined transport direction.

An exemplary stop module of this kind is known from DE 40 35 286 C2.

In practice, stop modules of this kind are also sometimes referred to as separating stops. They are used to position individual objects moving on a transport section at a processing station and/or to isolate them from a group or accumulation of objects. The objects to be isolated are usually workpieces, which are subject to further processing in one or more operations on the transport section. The transport section can be a conveyor belt, for example, on which the workpieces or workpiece carriers are moved in a defined transport direction. Ahead of a processing station, the workpieces or workpiece carriers on which the workpieces are situated must be braked and positioned as precisely as possible to allow processing of the workpieces. After processing, the workpieces or workpiece carriers are generally transferred onward with the conveyor belt, e.g. to a further processing station. The stop member arranged on the stop module is used to brake the workpieces or to brake the workpiece carrier at the processing station.

The prior art discloses a multiplicity of solutions which allow such positioning or isolation of objects or workpieces on a transport section. At the same time, the stop modules known from the prior art can be divided roughly into two type-specific classes. A first class concerns stop modules with rigid stops, which can only be extended into or retracted from the transport section in order to stop or release the workpieces at the processing station. In comparison with the second type-specific class of stop module, these stop modules do not have a damping device, and therefore the workpieces or the workpiece carriers are braked relatively abruptly at the processing station. They are therefore not suitable for positioning or isolating sensitive or even fragile workpieces. In comparison with the second type-specific class of stop module, however, stop modules of this kind can generally be made in a mechanically simpler way.

The second type-specific class of stop module concerns stop modules which are fitted with a damping device in order to brake the workpieces or workpiece carriers gently at the processing station. The present disclosure belongs to the type of stop module which has a damping device, and therefore this will be explored in greater detail below.

A practical example of the use of damped stop modules of this kind is the filling of jars or bottles and the subsequent closure of the jars or bottles at a plurality of processing stations, through which the jars or bottles run in succession. The jars or bottles can each be arranged on a workpiece carrier, which is moved in the defined transport direction on a conveyor belt or by some other transport mechanism (e.g. a roller belt), referred to below more generally as a transport section. With the aid of the stop member, the stop module can brake the workpiece carrier in a damped manner and hold it while the conveyor belt continues on below the workpiece carrier. As soon as processing has been carried out, the stop member is pulled back out of the transport section in a retraction movement, and therefore the transport section is released again and the workpiece carrier together with the workpiece can be conveyed to the next processing station.

It can easily be seen that a stop module of this kind must meet different requirements, depending on the type and weight of the workpieces. During the filling of jars or bottles mentioned in the above example, it is desirable, for example, that the workpieces should be braked gently in order to avoid tipping over or damage of the jars and/or slopping of the liquid introduced. This is ensured, in particular, by the damping device integrated into the stop module. On the other hand, a very rapid extension and/or retraction movement of the stop member into the transport section or out of the latter is extremely important owing to the high processing speeds which are generally required. In addition to a particularly rapid extension and/or retraction mechanism for the stop member, this also makes special demands on the damping device, which must therefore be ready for operation again very quickly after a braking or damping process.

DE 40 35 286 C2, mentioned at the outset, describes a stop module of this kind. The known stop module has a fluidic damping device connected to the stop member in order to move the stop member in a damped manner from a stop position to an end stop position during the stopping of an object. During this movement, the damping device is moved out of its initial position into its end position. In order to subsequently release the object again, the stop member is moved out of the transport section by means of a fluidically operated actuator in a retraction movement. This fluidically operated actuator also acts as part of the resetting means of the damping device. It has an actuating piston, which is moved downward together with the stop member by means of a pressure line during the retraction movement. During this retraction movement, the piston moves over a fluid outlet opening, which opens into the cylinder chamber in which the piston moves. By moving over this fluid outlet opening, the piston exposes a pressure line, via which the damping device is reset fluidically to its initial position.

Even if the stop module known from DE 40 35 286 C2 has often proven itself in practice, the two following disadvantages, in particular, have emerged over time.

On the one hand, the stop module has to be re-machined in some cases after a leak test. The reason for this re-machining is the fact that it is not entirely easy to ensure leaktightness between the piston sealing assembly arranged around the piston and the fluid outlet opening opening into the cylinder chamber, over which the piston and the piston sealing assembly move during each retraction and extension movement. In order to be able to ensure adequate leaktightness and avoid damage to the piston sealing assembly, the fluid outlet opening and the piston must therefore be deburred frequently during a re-machining process. This gives rise to increased outlay on manufacture and assembly. Moreover, the piston sealing assembly required for this purpose is relatively expensive.

Another disadvantage is that the guide housing has to be connected to the main housing not only via the actuating piston but also via an “air transfer sleeve”, within which part of the pressure line for resetting the damping device is provided. Since the guide housing is moved relative to the main housing during the retraction and extension movement, the air transport sleeve must also be moved at the same time.

### SUMMARY OF THE INVENTION

It is thus an object to provide an alternative stop module having a damping device, which stop module is of simpler configuration in terms of mechanical aspects and is less prone to faults.

According to an aspect of the present disclosure, a stop module is provided, comprising:
a stop element, which is configured to be moved into a transport plane to stop an object, and configured to be moved out of the transport plane to release the object;
a fluidic damping device, which is configured to move the stop element in a damped manner from an initial position of the damping device into an end position of the damping device in a working movement during the stopping of the object, wherein the damping device comprises a first piston-cylinder arrangement having a damping piston which is movable within a damping cylinder;
a fluidically operated actuator, which is configured to move the stop element into the transport plane in an extension movement and out of the transport plane in a retraction movement, wherein the actuator comprises a second piston-cylinder arrangement having an actuating piston which is movable within an actuating cylinder; and
a resetting device, which comprises a pressure line opening into the damping cylinder and is configured to move the damping device back from the end position into the initial position in a resetting movement by means of a pressurized fluid that is passed through said pressure line;
   wherein a duct-like passage opening, which forms a first subsection of the pressure line, is provided in an interior of the actuating piston

This renders obsolete the complex principle known from DE 40 35 286 C2, in which the actuating piston moves over a fluid outlet opening opening into the cylinder chamber to expose the pressure line. Instead, part of the pressure line runs through the interior of the actuating piston itself, namely through the duct-like passage opening arranged therein. The above-described disadvantages of the increased manufacturing and assembly outlay and of the necessity of a relatively expensive piston sealing assembly can thus be eliminated.

According to the disclosure, the actuating piston acts not only as a force-transmitting actuator for the extension and retraction movement of the stop member into and out of the transport section but also as part of the pressure line used for the resetting device of the damping device. Since the pressure line is passed through the interior of the pressure piston, there is no longer a need for a separate air transport sleeve of the kind provided in DE 40 35 286 C2 as a pressure line transition between the main housing and the guide housing. It is thereby not only possible to reduce the total number of components of the stop module but also to significantly simplify the overall structure thereof. It is thereby possible to reduce not only the cost of materials but also assembly costs.

In comparison with the stop module known from EP 1 777 177 B1, it is possible, in the case of the stop module according to the disclosure, to dispense with a separate electric actuating element to ensure the retraction and extension movement of the stop member. Since both the resetting of the damping device and the retraction and extension movement of the stop member are fluidically operated (preferably air-operated), the stop module according to the disclosure has merely to be connected to a corresponding pressure line and does not require a separate electric connection, as is the case with the stop module known from EP 1 777 177 B1. According to EP 1 777 177 B1, the actuating piston is namely used merely as part of the resetting device of the damping device but not as an actuator for lowering and raising the guide housing during the extension and retraction movement of the stop member into and out of the transport section. Thus, the stop module according to the disclosure can also be produced at lower cost and with less susceptibility to faults in comparison with this already known stop module.

According to a refinement, the stop module comprises a main housing, in which the piston-cylinder arrangement of the fluidically operated actuator (in the present case referred to as the second piston-cylinder arrangement) is arranged, and furthermore comprises a guide housing, in which the piston-cylinder arrangement of the damping device (in the present case referred to as the first piston-cylinder arrangement) is arranged, wherein the guide housing is mounted movably in the main housing, and wherein the actuating piston acts on the guide housing so as to move the guide housing relative to the main housing to perform the retraction movement and the extension movement of the stop member, respectively.

Apart from the main housing, the guide housing, the actuating piston and the damping piston connected to the stop member, the stop module does preferably not include any further relatively large components. It is thus preferably constructed from relatively few, easily produced components. To save further costs, the actuating piston is preferably designed as an injection molded plastic part, and the guide housing and the main housing are each manufactured from an extruded profile.

According to another refinement, the guide housing is pivotably connected to the main housing via a pivot.

During the retraction and extension movement, the guide housing is thus pivoted about this pivot together with the stop member relative to the main housing. In contrast with the stop modules known from DE 40 35 286 C2 and EP 1 777 177 B1, the retraction and extension of the stop member is accomplished by means of a pivoting movement of the guide housing and not by a parallel movement thereof along a linear travel axis perpendicular to the transport direction.

The guide housing is preferably connected to the main housing via a spring element, which counteracts the actuating piston.

This spring element pushes the stop member upward together with the guide housing into the blocking position of the stop member. Conversely, the release position of the stop member is brought about by the force which is exerted on the guide housing by the actuating piston, said force counteracting the force of the spring element. This has the advantage that the stop member is moved automatically into its blocking position in the event of a failure of the compressed air, in which position it projects into the transport section and also remains therein until compressed air is once again present in the pressure line.

Moreover, provision is preferably made for a second subsection of the pressure line, which opens into the damping cylinder, to run within the guide housing, and for the first subsection of the pressure line to open into the second subsection of the pressure line in a contact region between the actuating piston and the guide housing.

Through the integration of the pressure line into the interior of the actuating piston and into the interior of the guide housing, it is possible to reduce the manufacturing accuracy to be maintained in the two housing parts (guide housing and main housing).

The actuating piston is preferably convexly or concavely curved in the contact region with the guide housing, wherein the guide housing has a convex or concave shape complementary thereto in the contact region. If the actuating piston has a convex shape in the contact region, the guide housing is concavely shaped in the contact region, and vice versa. The actuating piston and the guide housing preferably interact in the manner of a joint in the contact region. They are therefore connected to one another in articulated fashion, not rigidly. As a result, no internal stresses arise between the actuating piston and the guide housing during the pivoting movement in the retraction and extension of the stop member.

According to a further refinement, the actuating piston is at least partially spherical in the contact region. In corresponding fashion, the guide housing has the shape of a partially spherical shell (e.g. hemispherical shell) in the contact region. Instead of (partially) spherical contact surfaces, (partially) cylindrical mutually corresponding contact surfaces would also be conceivable since the articulated connection between the actuating piston and the guide housing has the function of a single-axis joint.

A seal element for sealing a transport point between the first and the second subsection of the pressure line is preferably provided in the contact region. This seal element is preferably secured on the actuating piston. The seal element is, for example, an O-ring, which, at an end of the actuating piston which makes contact with the guide housing, is arranged around an outlet of the duct-like passage opening. Instead of an O-ring, however, it is also possible to use some other seal element, which preferably completely surrounds said end of the duct-like passage opening.

It is furthermore preferred if a first end of the duct-like passage opening opens into the cylinder chamber of the actuating cylinder, and a second end of the duct-like passage opening opens into the second subsection of the pressure line in the contact region, wherein the actuating cylinder has an inlet opening, which is connected fluidically to the first end of the duct-like passage opening via the cylinder chamber of the actuating cylinder.

During the retraction movement, during which the stop member is moved out of the transport section, the pressurized fluid (preferably compressed air) passes through said inlet opening into the actuating cylinder, thereby moving the actuating piston within the actuating cylinder, wherein the actuating cylinder pivots the guide housing downward together with the stop member. During this process, the damping device is simultaneously also reset from the end position to the initial position, with the fluid that has entered the actuating cylinder entering the first end of the duct-like passage opening, being passed through the interior of the actuating piston, passing out of the actuating piston at the second end of the duct-like passage opening and entering the second subsection—provided in the guide housing—of the pressure line at a first end and emerging therefrom at an opposite second end, which opens into the damping cylinder.

According to another refinement of the stop module according to the disclosure, a restriction device for restricting the air flow within the pressure line is arranged between the first and the second end of the second subsection of the pressure line. On the one hand, this restriction device is used as a damping resistance during the working movement of the damping piston. On the other hand, this restriction device serves to ensure that the retraction movement, during which the guide housing is lowered and the stop member is moved out of the transport section, takes place more rapidly than the resetting of the damping device. Otherwise, the damping piston would be moved back out of the damping piston too quickly during the retraction movement, during which the workpiece or workpiece carrier on the transport section is released, and, in the process, could push the workpiece or workpiece carrier back counter to the transport direction, which is not desired. Accordingly, resetting of the damping device with a time delay in comparison with the retraction movement is advantageous.

According to another refinement, the first restriction device has an adjusting element, preferably an adjusting screw, for adjusting the damping force of the damping device. By means of this adjusting element, the cross section of the pressure line can be modified, thereby enabling the damping force of the damping device to be varied.

According to another refinement, a travel of the actuating piston for bringing about the retraction movement of the stop member is shorter than a travel of the damping piston from the end position back into the initial position. Similarly to the abovementioned first restriction device, this brings about a quicker retraction movement of the stop member in comparison with the resetting movement of the damping device. As already mentioned, this serves to avoid a workpiece or a workpiece carrier accidentally being pushed back counter to the transport direction.

It is furthermore preferred if the stop module has a second restriction device, which is arranged at a fluid inlet connected to the actuating cylinder, wherein a flow resistance of the first restriction device is greater than a flow resistance of the second restriction device. This too assists the desired offset timing of the resetting movement of the damping device.

It is self-evident that the features mentioned above and those which will be explained below can be used not only in the respectively indicated combination but also in other combinations or in isolation without exceeding the spirit and scope of the present disclosure.

### BRIEF DESCRIPTION OF THE DRAWINGS

FIG. 1 shows a simplified illustration of a production system having a transport section on which a plurality of stop modules can be employed;

FIG. 2 shows a perspective illustration of one illustrative embodiment of the herein presented stop module;

FIG. 3 shows a sectional view of the illustrative embodiment of the stop module shown in FIG. 2 in a first position;

FIG. 4 shows a sectional view of the illustrative embodiment of the stop module shown in FIG. 2 in a second position; and

FIG. 5 shows a sectional view of the illustrative embodiment of the stop module shown in FIG. 2 in a third position.

### DESCRIPTION OF PREFERRED EMBODIMENTS

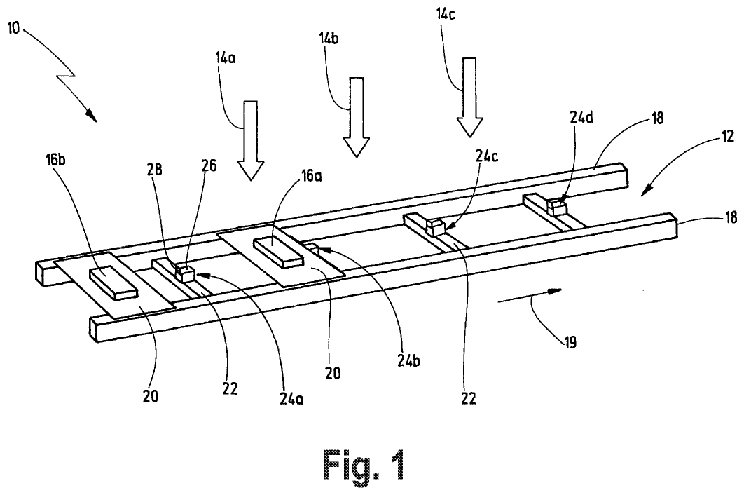

In FIG. 1, a system in which a plurality of stop modules is employed is denoted overall by the reference number 10.

The system 10 contains a transport section 12 and a number of processing stations 14, at which objects, generally in the form of workpieces 16, are processed in succession. By way of example, it can be a system for packing and labeling foodstuffs. However, the use of the stop module according to the disclosure is not restricted to this example. On the contrary, the stop module according to the disclosure can be used in any type of system which contains a transport section for conveying single items if the single items are to be selectively stopped at defined positions on the transport section.

In the case illustrated, the transport section 12 has two parallel tracks 18, on which a conveyor belt, a chain, a roller belt or the like revolves in the direction of the arrow 19. The arrow 19 illustrated in FIG. 1 indicates the transport direction of the transport section 12. As an alternative, the transport section 12 could have transverse rollers, for example.

Here, workpiece carriers 20 are placed on the transport section 12 transversely to the two tracks 18. Each workpiece carrier 20 carries a workpiece 16 and conveys the latter on the tracks 18 in the transport direction 19.

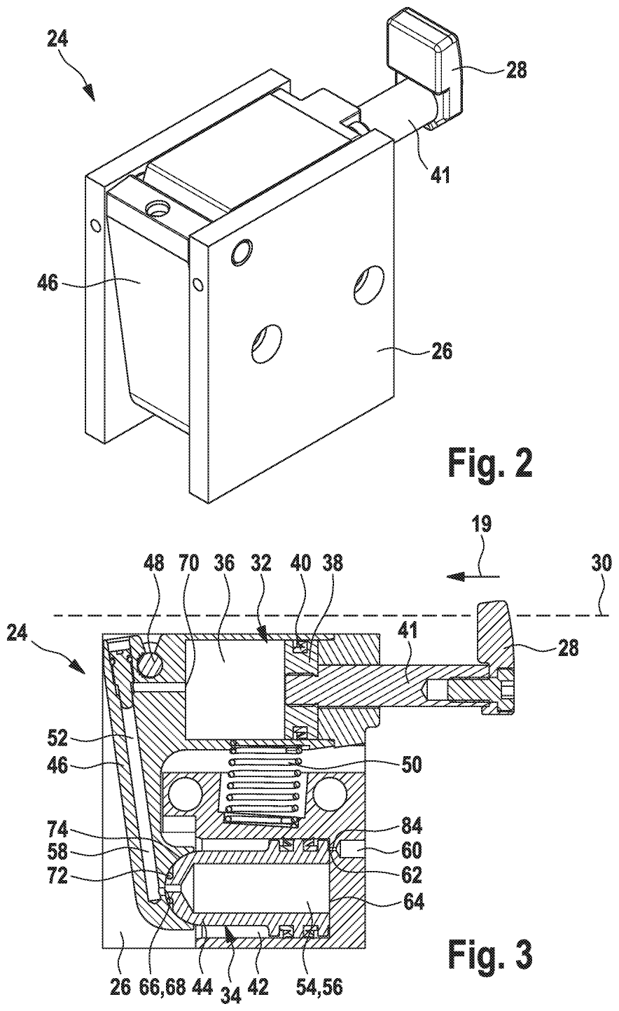

Here, four crossmembers 22, on each of which a stop module 24 is secured, are arranged between the two tracks 18. Each stop module 24 has a main housing 26 and a stop member 28, which can be moved relative to the main housing 26. An illustrative embodiment of the stop module 24 according to the disclosure is illustrated in perspective in FIG. 2.

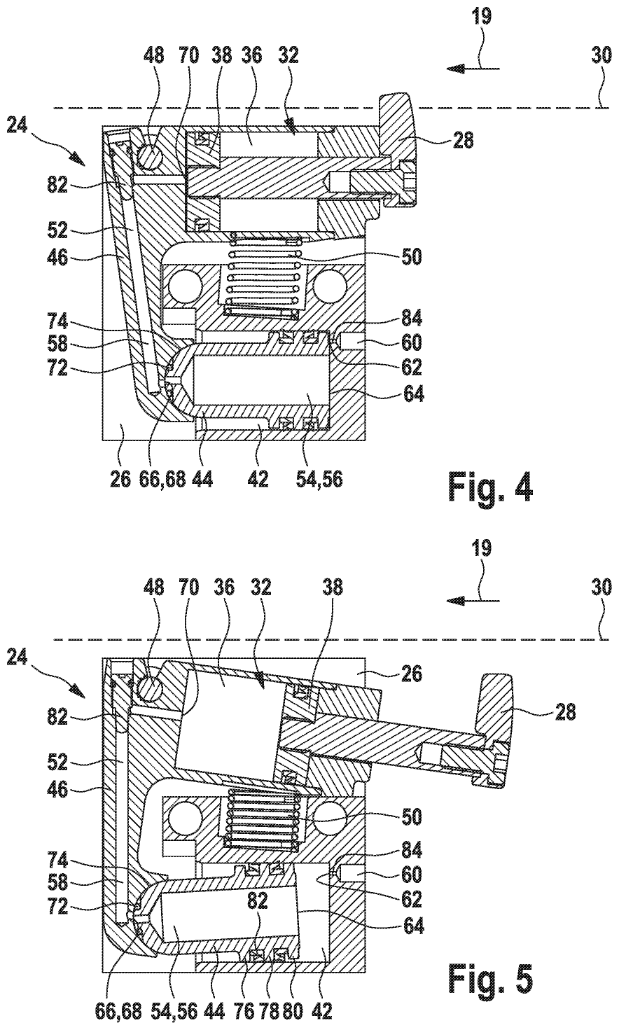

As explained in greater detail below with reference to the other figures, the stop member 28 can be moved into the transport section 12 during an extension movement and moved out of said transport section in a retraction movement. If the stop member 28 is in its lower working position (see FIG. 5, for example), the stop module 24 frees the transport section 12, allowing the workpiece carrier 20 to slide over the stop module 24 on the two tracks 18. If, on the other hand, the stop member 28 is in its upper working position (see FIGS. 3 and 4 for example), in which it projects into the transport section 12, it hinders the conveyance of the workpiece carrier 20 on the transport section 12, with the result that the workpiece carrier 20 is held fast or braked at a defined position. In this case, the conveyor belt, the chain, the roller belt or the like can continue on below the stopped workpiece carrier 20, i.e. the workpiece carrier 20 is held against the movement of the transport section 12. As soon as the stop member 28 is lowered again, i.e. is retracted from the transport section, the corresponding workpiece carrier 20 is conveyed onward.

With the aid of the four stop modules 24a-24d illustrated in the case of FIG. 1, it is thus possible to stop the workpieces 16 which are being conveyed in succession on the transport section 12 in a precise position at processing stations 14a-14c. In FIG. 1, the workpiece carrier 20 has run past the stop module 24a with the workpiece 16a, for example, and is now held fast by the second stop module 24b at the defined position for processing station 14a. After the release of the workpiece carrier 20 with workpiece 16a, the stop member 28 of the first stop module 24a has been moved back up into the transport section 12 in order to stop the next workpiece carrier 20 with workpiece 16b. Thus, the stop modules 24a-24d arranged in series with one another ensure the positioning of the workpieces when they are each controlled individually in succession by a system controller (not illustrated here) in such a way that a workpiece carrier 20 with a workpiece 16 passes in steps through the processing stations 14a-14c.

FIGS. 3-5 show sectional views of the illustrative embodiment, illustrated in FIG. 2, of the herein presented stop module 24 in various operating positions which occur during the use of the stop module 24.

FIG. 3 shows the operating position which the stop module 24 usually occupies before a workpiece carrier 20 strikes against the stop member 28. In this case, the stop member 28 projects into a transport plane situated above the main housing 26, which is depicted in dashed lines and is provided with the reference number 30.

FIG. 4 shows the operating position of the stop module 24 after a workpiece carrier 20 has struck the stop member 28 and has been braked by the latter. During this braking process, the stop member has moved in the transport direction 19 relative to the main housing 26 (cf. FIGS. 3 and 4). During the operation of the stop module 24, the operating position illustrated in FIG. 4 thus generally directly follows the operating position illustrated in FIG. 3. As before, the stop member 28 projects into the transport plane 30, with the result that, as before, the braked workpiece carrier is held fast and thus cannot move further on the transport section 12.

FIG. 5 shows the operating position of the stop module 24 in which a workpiece carrier 20 situated on the transport section 12 is released and can move further in the transport direction 19. In comparison with the operating position illustrated in FIG. 4, the stop member 28 has been moved downward for this purpose out of the transport plane 30 in a retraction movement.

The functions and components required to ensure the operation of the stop module 24 are explained in greater detail below with reference to FIGS. 3-5.

The stop module 24 has a damping device 32 for damping the stop member 28. Furthermore, the stop module 24 has an actuator 34, which is configured to move the stop member 28 out of the transport plane 30 in a retraction movement or to move it into the transport plane 30 in an opposite extension movement.

In the illustrative embodiment illustrated, the damping device 32 is designed as a piston-cylinder arrangement. It has a damping cylinder 36 and a damping piston 38 movable therein. The sealing between the damping cylinder 36 and the damping piston 38 is preferably accomplished by means of a seal element 40 arranged on the damping piston 38. The damping piston 38 of the damping device 32 is connected to the stop member 28 by a connecting element 41. This connection is a rigid connection. Accordingly, a movement of the stop member 28 in the transport direction 19 which occurs during a braking process of a workpiece carrier 20 also brings about a movement of the damping piston 38 in the same direction 19 within the damping cylinder 36. The position of the damping device 32 before this movement (see FIG. 3) is referred to in the present case as the initial position of the damping device 32. The position of the damping device 32 after this damping movement, i.e. the position in which the damping piston 38 has been retracted completely into the damping cylinder 36 (see FIG. 4), is referred to in the present case as the end position of the damping device 32.

The actuator 34 comprises a second piston-cylinder arrangement with an actuating piston 44 that can be moved within an actuating cylinder 42. The actuator 34 brings about the retraction movement, with the aid of which the stop member 28 is moved out of the transport plane 30 in order to release a workpiece carrier 20 situated on the transport section 12. Conversely, the actuator 34 also brings about, at least indirectly, the extension movement, in which the stop member 28 is pivoted back into the transport plane 30 in order to stop the next workpiece carrier 20 approaching on the transport section 12. When the actuator 34 is deactivated, the extension movement is set in motion. A spring element 50, which is arranged between the main housing 26 and the guide housing 46, acts counter to the actuating piston 44 during this pivoting movement and thus brings about the extension movement. In the stop module 24 according to the illustrative embodiment under consideration, both movements (retraction and extension movement) are accomplished by pivoting the stop member 28. During this process, the stop member 28 is pivoted about a pivot 48, together with a guide housing 46 mounted so as to be rotatable relative to the main housing 26.

Both components, i.e. both the damping device 32 and the actuator 34, are fluidically operated in the stop module 24. This fluidic operation is preferably accomplished by means of compressed air. In principle, however, hydraulic operation of both components would also be possible.

The damping device 32 is reset by means of the very same pressure line 52 by means of which the movement of the actuating piston 44 of the actuator 34 is also controlled.

Resetting of the damping device 32 is taken to mean the process in which the damping device 32 is brought back from the end position shown in FIG. 4 into its initial position shown in FIG. 5 and the damping piston 38, together with the connecting element 41 and the stop member 28, is extended again relative to the damping cylinder 35.

The pressure line 52 has a plurality of subsections. One subsection 54, which is referred to in the present case as the first subsection, runs through the interior of the actuating piston 44. This first subsection 54 of the pressure line 52 is designed as a duct-like passage opening 56 which traverses the actuating piston 44. In the illustrative embodiment of the stop module 24 shown in the present case, this passage opening 56 is of symmetrical design with respect to the longitudinal axis of the actuating piston 44. However, this does not necessarily have to be the case. Eccentric arrangement of the passage opening 56 within the actuating piston 44 could also be considered in principle. Subdivision of the passage opening 56 into two partial bores of different diameters, as illustrated in FIGS. 3-5, is likewise not absolutely essential.

Another subsection 58 of the pressure line 52, which is referred to here as the second subsection, runs in the interior of the guide housing 46. This second subsection 58 of the pressure line 52 connects the first subsection 54 arranged in the interior of the actuating piston 44 to the interior of the damping cylinder 36.

More specifically, the retraction or lowering movement of the stop member 28 is brought about as follows: a pressurized fluid (preferably compressed air) is introduced into the stop module 24 via a fluid inlet 60 provided in the main housing 26. From there, it passes via an inlet opening 62 opening into the actuating cylinder 42 into the interior of the actuating cylinder 42. This causes a movement of the actuating piston 44 relative to the actuating cylinder 42. In the illustrative embodiment under consideration, the actuating piston 44 moves substantially but not exactly parallel to the transport direction 19 (to the left in FIGS. 3-5). The movement of the actuating piston 44 causes the already mentioned pivoting movement of the guide housing 46 about the pivot 48, as a result of which the stop member 28 is pivoted downward out of the transport plane 30, in the present case clockwise (see FIG. 5).

During this pivoting movement, the fluid introduced into the actuating cylinder 42 through the fluid inlet 60 and the inlet opening 62 passes through the first subsection 54 of the pressure line 52, provided in the interior of the actuating piston 44, into the second subsection 58 of the pressure line 52, which passes through the guide housing and ultimately opens into the damping cylinder 36. Thus, during the extension movement of the stop member 28, the resetting of the damping device 32 therefore also takes place at the same time.

A first end 64 of the passage opening 56 provided in the actuating piston 44 opens into the interior of the actuating cylinder 42. The second end 66 of the passage opening 56 opens directly into a first end 68 of the second subsection 58 of the pressure line 52. The opposite end of the second subsection 58 of the pressure line 52, which is denoted as the second end 70 in the present case, opens directly into the damping cylinder 36. The sealing between the first subsection 54 and the second subsection 58 of the pressure line 52 is accomplished by means of a seal element 72, which is preferably arranged on the actuating piston 44 around the second end 66 of the passage opening 56. This can be an O-ring, for example, which is fixed in a corresponding recess on the actuating piston 44.

As can furthermore be seen from FIGS. 3-5, the actuating piston 44 and the guide housing 46 are formed in the manner of spheres or spherical shells in a contact region 74, in which they make contact with each other. The actuating piston 44 and the guide housing 46 therefore interact in the manner of an at least single-axis joint in the contact region 74. They are therefore connected to one another in an articulated fashion by means of their respective contact surfaces. In the illustrative embodiment under consideration, the contact surface provided on the guide housing 46 is a concave surface which is shell-shaped and the contact surface provided on the actuating piston 44 is a convex surface, which preferably has the shape of a hemisphere. However, it should be noted that, in principle, it would also be possible to provide the concave guiding surface on the actuating piston 44 and to arrange the correspondingly convexly shaped contact surface on the guide housing 46. The present disclosure is likewise not restricted to the spherical shape or the shape of a spherical shell. In principle, a cylindrical contact surface or a contact surface in the form of a cylindrical shell would also be possible in the contact region 74 between the actuating piston 44 and the guide housing 46.

As can be seen from a comparison of FIGS. 4 and 5, the actuating piston 44 likewise carries out a slight pivoting movement during the pivoting movement of the guide housing 46 and does not travel only in translation along its longitudinal axis. The second end 66 of the passage opening 56 is therefore preferably arranged in a manner vertically offset somewhat relative to the first end 68 of the second subsection 58. In this way, it is possible to ensure that the pressure line 52 is not closed during the pivoting movement of the actuating piston 44. In principle, it would also be possible to make the diameter of the first subsection 54 larger at the second end 66 or to make the diameter of the second subsection 58 larger at the first end 68 thereof. However, this would make sealing more difficult in the contact region 74 between the actuating piston 44 and the guide housing 46.

In order to allow the abovementioned pivoting movement of the actuating piston 44 and nevertheless to ensure adequate leaktightness, the actuating piston 44 has three radially encircling webs 76, 78, 80 on the outer circumference thereof, wherein the outer two webs 76, 80 have a larger diameter than the web 78 arranged therebetween (see FIG. 5). The actuating piston 44 is thus guided by means of the central web 78 and tilts over said web, wherein the outer webs 76, 80 limit the tilt angle. Arranged between the webs 76, 78, 80 is a sealing assembly 82, preferably consisting of two seal elements.

The stop module 24 furthermore has two restriction devices, a first restriction device 82 and a second restriction device 84. The first restriction device 82 is preferably esigned as an adjusting screw in order to be able to modify the flow resistance caused by restriction device 82. The first restriction device 82 is arranged between the two ends 68, 70 of the second subsection 58 of the pressure line 52. The main function of this restriction device 82 is to enable the damping force of the damping device 32 to be varied. The second restriction device 84 is arranged between the fluid inlet 60 arranged on the outside of the main housing 26 and the inlet opening 62 of the actuating cylinder 42. This second restriction device 84 is preferably esigned as a narrowing of the cross section in the fluid inlet duct. It is furthermore preferred if a flow resistance of the first restriction device 82 is higher than a flow resistance of the second restriction device 84. This ensures that the retraction movement of the stop member 28 is brought about more quickly than the resetting of the damping device 32. This prevents a stopped workpiece carrier 20 accidentally being pushed back counter to the transport direction 19 during the retraction movement, during which the damping device 32 is simultaneously reset. For the same purpose, it is preferred if a travel of the actuating piston 44 for bringing about the retraction movement of the stop member 28 is shorter than a travel of the damping piston 38 from the end position back into the initial position of the damping device 32.

Finally, attention is drawn once again to the ability for relatively low-cost production of the stop module 24. It consists of relatively few components. The guide housing 46 and the main housing 26 can be manufactured from an extruded profile. Owing to the coupling between the guide housing 46 and the main housing 26 via the actuating piston 44 and the second subsection 58, integrated therein, of the pressure line 52, various finishing operations on the guide housing 46 and the main housing 26, which would otherwise generally be necessary, can be eliminated. The actuating piston 44 can also be produced in a relatively simple manner. It is preferably designed as an injection molded plastic part. This also contributes positively to reducing the weight of the stop module 24.

Even if the starting point in the drawings is in each case an arrangement of the stop module 24 below the transport plane 30, the stop module 24 can also be positioned to the side of or above the transport plane without exceeding the spirit and scope of the present disclosure. In the case of arrangement to the side, the stop module 24 must merely be arranged in a manner turned through 90°. In the case of arrangement above the transport plane 30, the stop module 24 would have to be arranged in a manner turned through 180° and would then project from above into the transport plane 30 in order to stop a workpiece or workpiece carrier.

What is claimed is:

1. A stop module for stopping an object, which is moved on a transport section with a defined transport direction, comprising:
a stop element, which is configured to be moved into a transport plane to stop an object, and configured to be moved out of the transport plane to release the object;
a fluidic damping device, which is configured to move the stop element in a damped manner from an initial position of the damping device into an end position of the damping device in a working movement during the stopping of the object, wherein the damping device comprises a first piston-cylinder arrangement having a damping piston which is movable within a damping cylinder;
a fluidically operated actuator, which is configured to move the stop element into the transport plane in an extension movement and out of the transport plane in a retraction movement, wherein the actuator comprises a second piston-cylinder arrangement having an actuating piston which is movable within an actuating cylinder; and
a resetting device, which comprises a pressure line opening into the damping cylinder and is configured to move the damping device back from the end position into the initial position in a resetting movement by means of a pressurized fluid that is passed through said pressure line;
wherein a duct-like passage opening, which forms a first subsection of the pressure line, is provided in an interior of the actuating piston.

2. The stop module as claimed in claim 1, wherein the stop module comprises a main housing, in which the second piston-cylinder arrangement is arranged, and a guide housing, in which the first piston-cylinder arrangement, which is connected to the stop member, is arranged, wherein the guide housing is mounted movably in the main housing, and wherein the actuating piston acts on the guide housing so as to move the guide housing relative to the main housing to perform the extension movement and the retraction movement of the stop member, respectively.

3. The stop module as claimed in claim 2, wherein the guide housing is pivotably connected to the main housing via a pivot.

4. The stop module as claimed in claim 3, wherein the guide housing is furthermore connected to the main housing via a spring element, which counteracts the actuating piston.

5. The stop module as claimed in claim 2, wherein a second subsection of the pressure line runs within the guide housing, wherein the first subsection of the pressure line opens into the second subsection of the pressure line in a contact region in which the actuating piston contacts the guide housing.

6. The stop module as claimed in claim 5, wherein the actuating piston is convexly or concavely curved in the contact region, and the guide housing has a convex or concave shape complementary thereto in the contact region, and wherein the actuating piston and the guide housing are connected to one another in an articulated manner in the contact region.

7. The stop module as claimed in claim 6, wherein the actuating piston is at least partially spherical in the contact region.

8. The stop module as claimed in claim 5, wherein a seal element for sealing a transport point between the first and the second subsection of the pressure line is arranged in the contact region, said seal element being secured on the actuating piston.

9. The stop module as claimed in claim 5, wherein a first end of the duct-like passage opening opens into the actuating cylinder, and a second end of the duct-like passage opening opens into the second subsection of the pressure line in the contact region, and wherein the actuating cylinder has an inlet opening, which is connected fluidically to the first end of the duct-like passage opening via the actuating cylinder.

10. The stop module as claimed in claim 5, wherein a first end of the second subsection of the pressure line opens into the first subsection of the pressure line in the contact region, and wherein a second end of the second subsection of the pressure line opens into the damping cylinder.

11. The stop module as claimed in claim 10, wherein a first restriction device, which restricts the air flow within the pressure line, is arranged between the first and the second end of the second subsection of the pressure line.

12. The stop module as claimed in claim 11, wherein the first restriction device comprises an adjusting element for adjusting the damping force of the damping device.

13. The stop module as claimed in claim 1, wherein a travel of the actuating piston during the retraction movement of the stop member is shorter than a travel of the damping piston from the end position back into the initial position.

14. The stop module as claimed in claim 11, further comprising a second restriction device, which is arranged at a fluid inlet connected to the actuating cylinder, wherein a flow resistance of the first restriction device is greater than a flow resistance of the second restriction device.

15. The stop module as claimed in claim 1, wherein the actuating piston is an injection molded plastic part, and the guide housing and the main housing are each manufactured from an extruded profile.
